(19) United States
(12) Patent Application Publication
(10) Pub. No.: US 2008/0318652 A1
(43) Pub. Date: Dec. 25, 2008

(54) Texas Holdem Peek-A-Boo Poker

(75) Inventors: Brad A. Lima, Somerset, MA (US); Thomas M. Ducharme, Swansea, MA (US); Neil J. Kolakowski, Fall River, MA (US); Gregory J. Lima, Westport, MA (US); John W. Asermely, Westport, MA (US)

Correspondence Address: COURTNEY STANIFORD & GREGORY LLP, P.O. BOX 9686, SAN JOSE, CA, 95157, US

(73) Assignee: GLOBAL VR, San Jose, CA (US)

(21) Appl. No.: 12/144,456

(22) Filed: Jun. 23, 2008

Related U.S. Application Data
(60) Provisional application No. 60/936,519, filed on Jun. 21, 2007.

(51) Int. Cl. A63F 9/24; A63F 13/00

(52) U.S. Cl. 463/13

(57) ABSTRACT

Embodiments described herein are directed to an electronic version of Texas holdem poker that adds peek cards from which the private hole cards can be selected. A player makes a wager for a hand or hands to be dealt. Three cards are dealt to the flop. Another three cards are “peek” cards. These three peek cards expose the identity/suit/denomination of the card by illustrating a fold of the top right corner. These cards are placed in respective peek 1, peek 2, and peek 3 spots of the playing area. Random cards are located to the left and right of the peek cards. Considering the flop, the player decides which of the cards he needs to make the best hands. If any of the peek cards are undesirable, a random card or cards are selected from the deck. The two cards the player picks are called the hole cards. Once the two hole cards are picked the turn and river cards are dealt. The player is awarded for the best possible five card hand out of the seven cards. When multiple hands are played, a wide variety of different winning hands can occur.

### CROSS-REFERENCE TO RELATED APPLICATIONS

This application claims priority from U.S. Provisional Patent Application No. 60/936,519, entitled “Texas Holdem Peek-a-Boo Poker”, filed Jun. 21, 2007, which is incorporated by reference in its entirety herein.

### TECHNICAL FIELD

Embodiments described herein relate generally to interactive entertainment systems, and more specifically to electronic video card games.

### BACKGROUND

Electronic card games, such as electronic poker have become a well established mainstay in casinos and gaming establishments around the world, and the advent of the Internet has given rise to many online versions of these games. The popularity of electronic or online poker has led to a significant rise in popular interest for the game in both the traditional, card-based format and the electronic computer-based format. Many electronic poker games are still based on the few well known variations of the basic game, such as five or seven card stud or draw poker. Computer implementation of poker has enabled various improvements over the basic game, such as security and anti-cheating measures, automated betting and prize distribution, and remote access for players. With regard to game play, current electronic poker systems are typically just simple and straightforward implementations of the card-based games on a computer platform. However, with the increased processing and graphical display power available in modern systems, many variations of well-known poker based games are possible.

One of the most popular poker games in casinos and card rooms across America and Europe is Texas holdem (or hold'em). Unlike stud or draw poker where each player holds a separate individual hand, Texas holdem is a community game where each player may use any combination of five community cards and the player's own two hole cards to make a poker hand. Because each player only starts with two cards and the remaining cards are shared, it provides a great deal of latitude for strategic analysis.

The advent of online poker sites has led to the tremendous increase in the popularity of Texas holdem as an online poker game. Online versions of the game, however are based strictly on the actual card based version. Varying certain aspects of the game may help to maintain its popularity in the online environment.

What is needed therefore, is an online version of Texas holdem that introduces certain novel variations over the traditional card-based version of the game.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates an electronic game screen for an online or electronic Texas holdem peek-a-boo poker game, according to an embodiment.

FIG. 2 illustrates the placing of a bet through the game screen, under an embodiment.

FIG. 3 illustrates the deal of flop cards and peeked cards for the Texas holdem peek-a-boo poker game, under an embodiment.

FIG. 4 illustrates the selection of the first hole card for the Texas holdem peek-a-boo poker game, under an embodiment.

FIG. 5 illustrates the selection of the second hole card for the Texas holdem peek-a-boo poker game, under an embodiment.

FIG. 6 illustrates the turn and river card display area for the Texas holdem peek-a-boo poker game, under an embodiment.

FIG. 7 illustrates the turn and river card display area for a fifty play game, under an embodiment.

FIG. 8 illustrates the turn and river card display area for a hundred play game, under an embodiment.

FIG. 9 is a block diagram of an electronic gaming system according to an embodiment.

FIG. 10 is a block diagram of an electronic gaming system according to another embodiment.

FIG. 11A is a table that illustrates the payout odds for possible winning hands in a one-credit Texas holdem peek-a-boo game, under an embodiment.

FIG. 11B is a table that illustrates the payout odds for possible winning hands in a 5-100 credit play Texas holdem peek-a-boo game, under an embodiment.

FIG. 11C are tables that illustrate the payout percentage and total possible hands for different credit play Texas holdem peek-a-boo games, under an embodiment.

### DETAILED DESCRIPTION

Embodiments described herein include variations of an electronic video Texas holdem poker game that provides peeked cards from which the player can select their hole cards.

In the following description, numerous specific details are introduced to provide a thorough understanding of, and enabling description for, embodiments of the online Texas holdem peek-a-boo poker game and game system. One skilled in the relevant art, however, will recognize that these embodiments can be practiced without one or more of the specific details, or with other components, systems, and so on. In other instances, well-known structures or operations are not shown, or are not described in detail, to avoid obscuring aspects of the disclosed embodiments.

Embodiments of the Texas holdem peek-a-boo poker game are played on an electronic game console or computer (hereinafter referred to as the “game platform” or the “game console”) that includes a central processing unit and a display, along with other components, such as memory, input/output devices, network access devices, and so on. A graphical user interface provides the game environment for the user and may be provided on a single display device, or multiple display devices including a display that is visible to multiple users at one time. A network of game consoles supporting respective players of the game may be referred to as the “Texas holdem peek-a-boo poker system.” This embodiment may be implemented in a kiosk-based game environment. Other embodiments may be implemented in a client-server network environment for distributed online play among networked computer users. Such an implementation may utilize the Internet through a web-based interface between a web server computer and a plurality of web browser client computers.

In standard Texas holdem, each player is dealt two cards face down from a standard 52-card deck. These cards are called the “hole” or “pocket” cards. The hand begins with a pre-flop betting round, beginning with the player on the dealer's left and continuing clockwise. A round of betting continues until every player has folded, put in all their chips, or matched the amount put in by all other active players. After the pre-flop betting round the dealer deals three face-up community cards or “flop” cards. This is followed by a second betting round proceeding counterclockwise from the player on the dealer's left. After the flop betting round ends, a single community card (called the turn or fourth street) is dealt. This is followed by a third betting round. A final single community card (called the river or fifth street) is then dealt, followed by a fourth betting round. This is followed by the showdown, which occurs if two or more players remain after the final betting round. On the showdown, each player plays the best five-card poker had he can make from the seven cards comprising his two hole cards and the five community cards.

In one embodiment, a card peeking element is added to an online version of Texas holdem. In this embodiment, a player makes a wager for a hand or hands to be dealt. Three cards are dealt to the flop. Another three cards are “peek” cards. These three peek cards expose the card's identity/suit/denomination by illustrating a fold of the top right corner. These cards are placed in respective peek 1, peek 2, and peek 3 spots of the playing area. Random cards are located to the left and right of the peek cards. Considering the flop, the player decides which of the cards he needs to make the best hands. If any of the peek cards are undesirable, a random card or cards are selected from the deck. The two cards the player picks are called the hole cards. Once the two hole cards are picked the turn and river cards are dealt. The player is awarded for the best possible five card hand out of the seven cards. Any number of hands can be played depending on the constraints of the system. When multiple hands are played, a wide variety of different winning hands can occur.

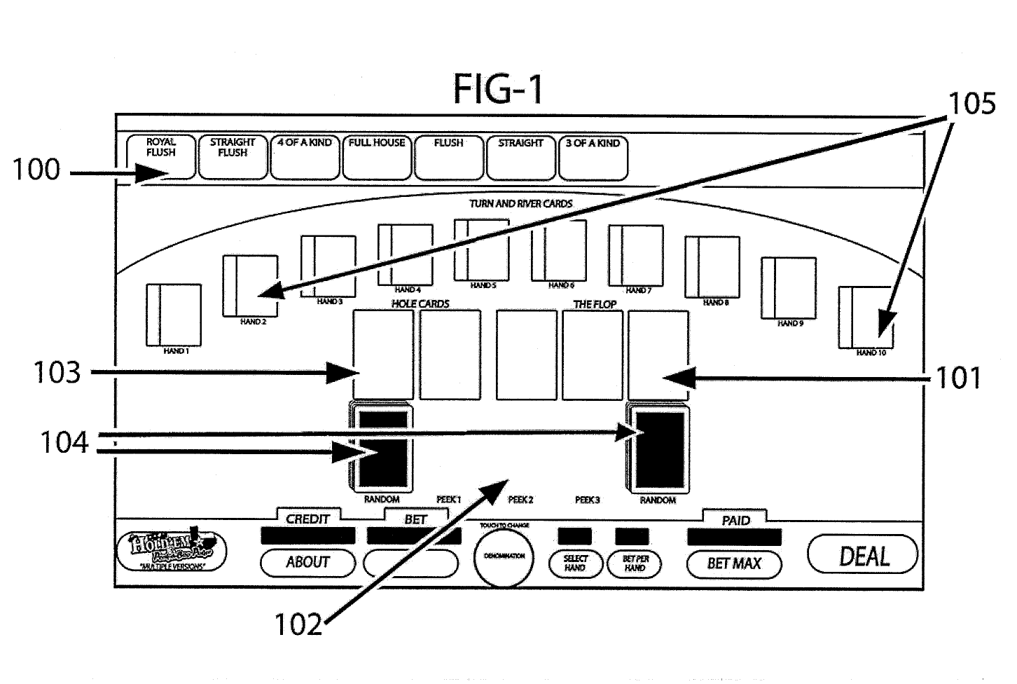

FIG. 1 illustrates an electronic game screen for an online or electronic Texas holdem peek-a-boo poker game, according to an embodiment. This is the basic screen of the graphical user interface before a player begins a game. The layout of the basic game screen may be configured in any number of ways, depending upon actual implementation based on system constraints and requirements. Before a bet is made, the player is presented with a pay table (100), which is displayed along the top of the screen. The paytable indicates the payout for various poker hands, such as a royal flush, a straight flush, etc, and appear in the blank boxes beneath the name of each hand. The game screen is configurable to display any desired predetermined payouts for each respective hand. The game screen has blank field spaces for the flop 101, peek cards 102, and hole cards 103. There is also a standard 52-card deck (no jokers) separated in two stacks 104 each labeled “random”. Empty spaces 105 where the turn and river cards are to be shown are located around these elements.

Below the two decks of cards 104 are display fields for displaying credits the player has won, the current total bet, and the amount paid. At the bottom of the screen are multiple buttons that allow the player to interact with the game. In an embodiment, the buttons may include a “START” or “CHANGE GAME” button that allows the player to choose a new or different game. The buttons further include an “ABOUT” or “HELP” button that, when pressed, displays instructions teaching the game. The buttons further include a “DEAL” button which starts the hand. The buttons further include a “BET” button that allows the player to specify an amount to bet, and a “BET MAX” button that places a bet for the maximum amount that the game offers.

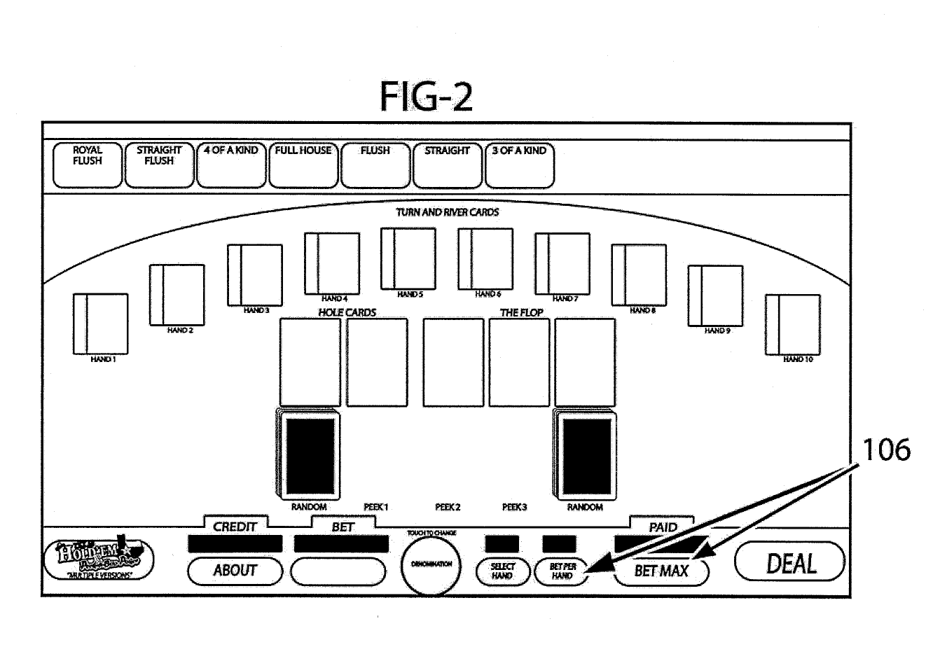

Play begins with the player making a bet in the appropriate area of the game screen. The bet amount can be in any appropriate denomination, such as money (of any currency), credits, chips, or any similar defined unit of value. FIG. 2 illustrates the placing of a bet through the game screen, under an embodiment. As shown in FIG. 2, the player makes a bet 106 by selecting the “bet per hand” and “bet max” command buttons on the game screen. The pay table 100 is then filled dynamically with predetermined amounts.

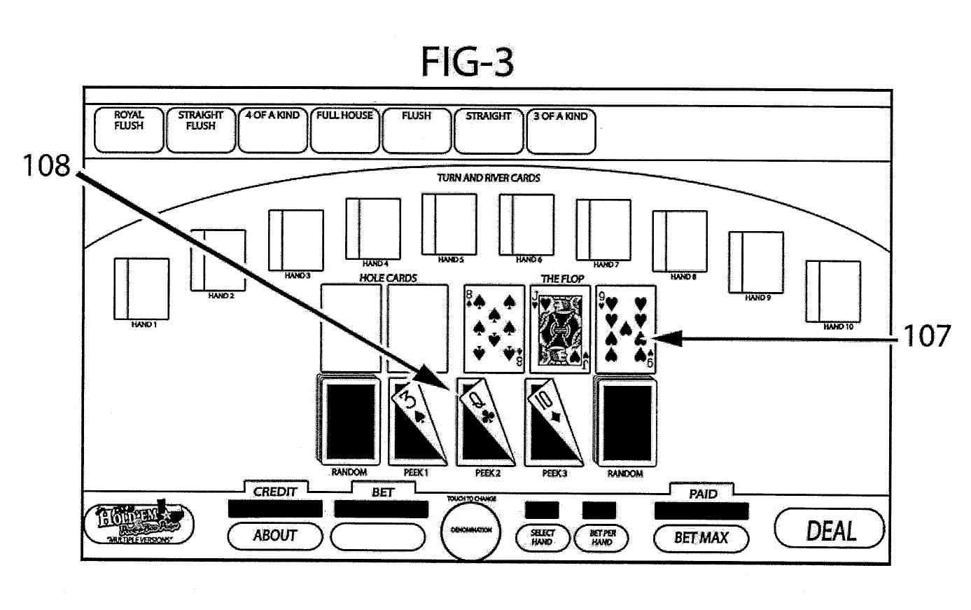

After the first bet is placed, the player is presented with three cards on the flop 107. The player is also presented with another three cards 108 that are peeked. FIG. 3 illustrates the deal of flop cards and peeked cards for the Texas holdem peek-a-boo poker game, under an embodiment. Peek cards are cards showing their value by having the card partially revealed. This can be implemented through a fold or curling of the card's corner the value and suit of the card, as shown in FIG. 3. Other means of partially revealing a card can also be used, such as by shading or stippling a card.

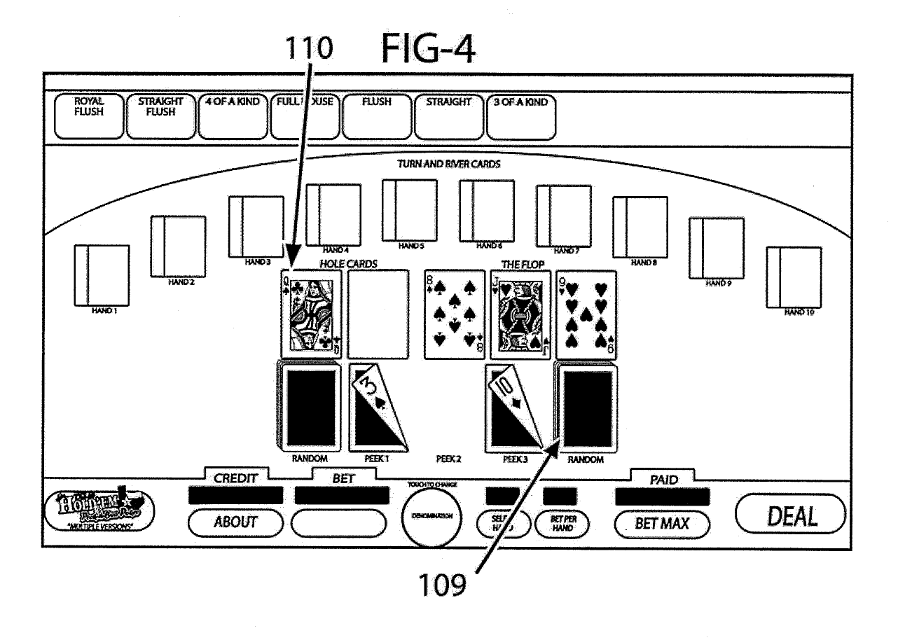

The player then proceeds to the select the first of two hole cards from either the onscreen deck 104 or peek cards 108, deciding which cards make the best winning hand or hands. FIG. 4 illustrates the selection of the first hole card for the Texas holdem peek-a-boo poker game, under an embodiment. As shown in FIG. 4, the player can either choose from the peek cards or from the random deck 109 to select their first hole card. The selected card is then placed into the first hole card field 110.

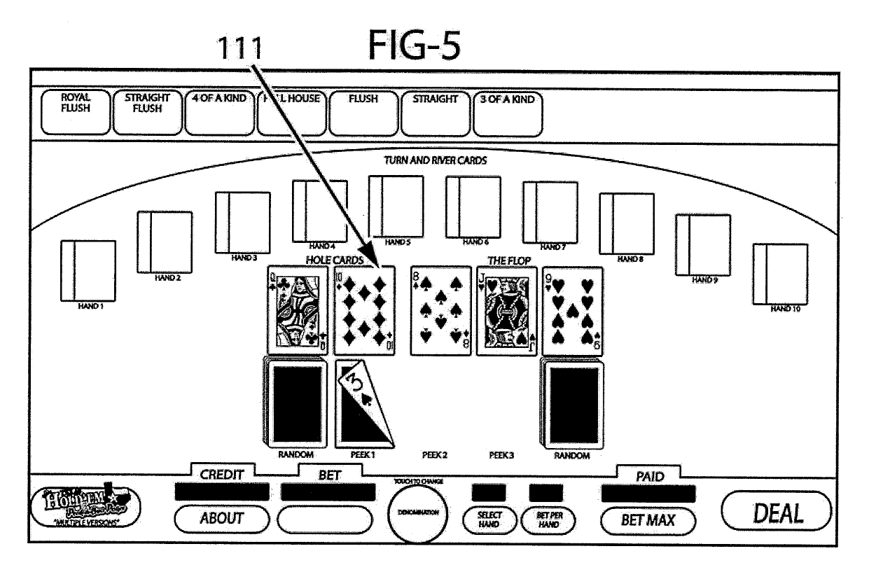

After the first hole card is selected, the player must then select the second hole card. FIG. 5 illustrates the selection of the second hole card for the Texas holdem peek-a-boo poker game, under an embodiment. Again, the second hole card can be selected from either the peek cards or the random deck. As shown in FIG. 5, the second hole card placed into the second spot of the hole card field 111.

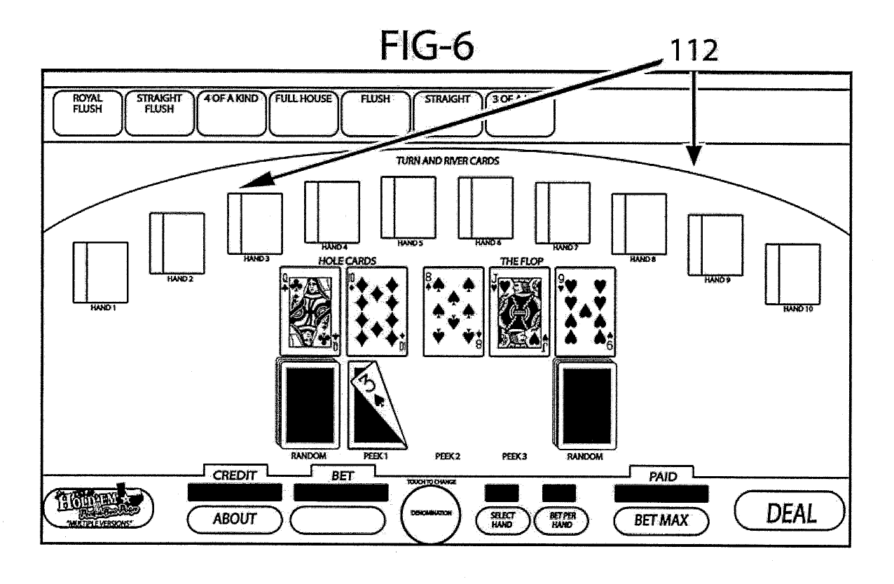

As play progresses, the turn and river cards are dealt and displayed in display area 112 in respective fields for each hand that is played. FIG. 6 illustrates the turn and river card display area, under an embodiment. After the turn and river cards are dealt, the player is paid for any five card poker hand that is deemed of value in the pay table. FIG. 6 illustrates a ten play game in which the turn and river cards are dealt into the appropriate field 112 according to the particular hand played. Thus, for the first hand, the turn and river cards are dealt into the space marked “Hand 1”, for the second hand they are dealt into the space marked “Hand 2”, and so on.

Four bets can be made in accordance with the sequence of standard Texas holdem using the “Bet per Hand” or “BET MAX” buttons shown in FIG. 1. Thus, a first bet is made by the player prior to presentation of the flop cards, a second bet is made following the presentation of the flop cards, a third bet is made following the presentation of the turn card, and a final bet is made following the presentation of the river card. The player may fold to end a hand prior to the placing of any of the bets.

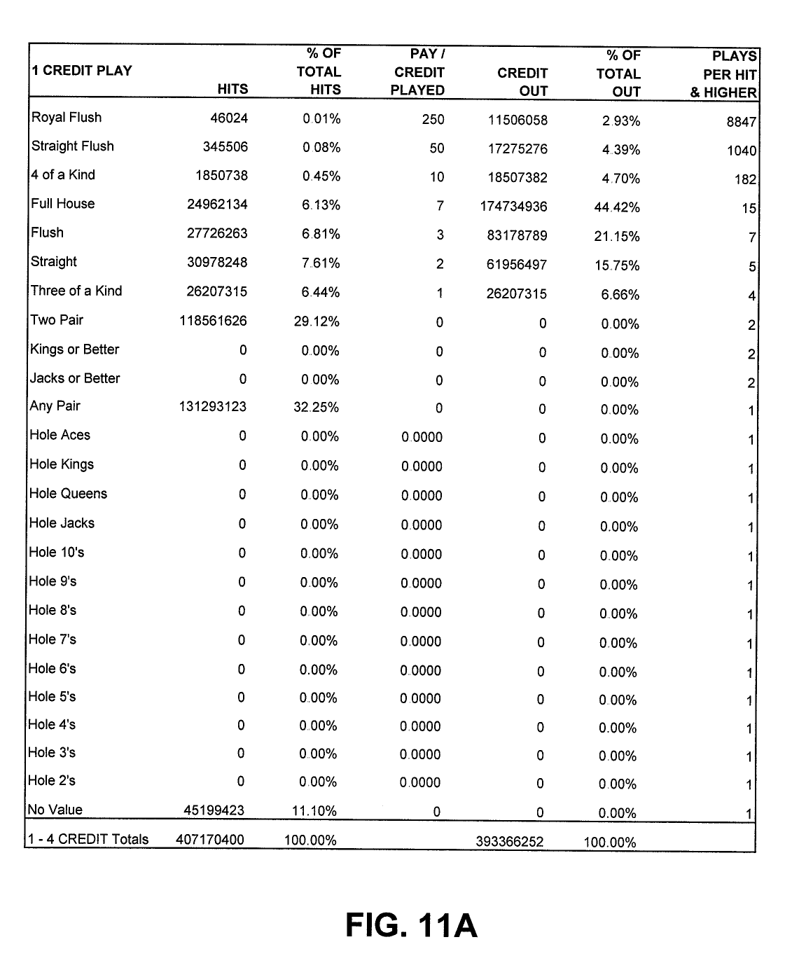

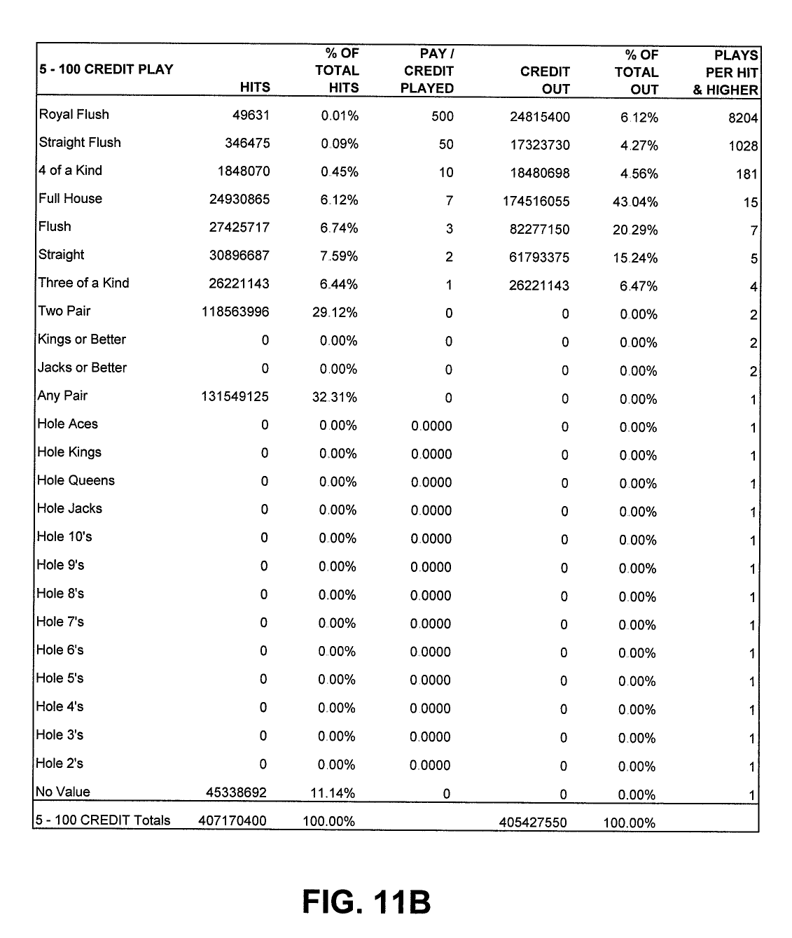

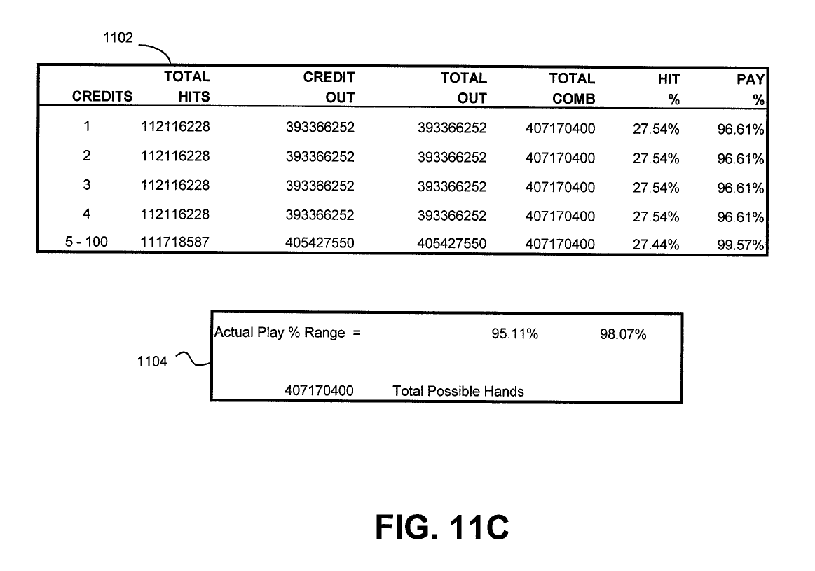

The pay out is made based on the best five card poker hand out of the seven cards comprising the hole cards 110 and 111, the flop cards 107, and the turn and river cards 112 for that particular hand. In one embodiment, the system determines the best possible hand of five card poker that can be formed from the seven cards. Alternatively, the player must identify the best hand and indicate this to the system. The best hand is selected based on the standard five card poker scheme ranging from three of a kind to a royal flush. Typically, hands in this range provide a payout, although many different types of hands are possible. FIG. 11A is a table that illustrates the payout amounts for each of the possible hands in five card poker, as used in the Texas holdem peek-a-boo poker game, under an embodiment. These hands correspond to the hands displayed in the payout table 100 of FIG. 1. In general, the greater the odds, the rarer the hand, and hands with greater payout odds beat those with lesser payout odds. The table of FIG. 11A illustrates the parameters for each hand based on one-credit play with a maximum credit percentage of 99.57% and a one credit percentage of 96.61%. FIG. 11B is a table that illustrates the payout amounts for possible winning hands in a 5-100 credit play Texas holdem peek-a-boo game, under an embodiment. FIG. 11C illustrates a table 1102 that correlates the payout percentage for the number of credits ranging from 1 to 100. It also shows a table 1104 that shows the actual play percentage range for 407,170,400 total possible hands.

When the poker hand in the hand field is complete, the player is shown the result of the hand. For example, if the hand is one of the hands in the paytable, the player is paid an amount indicated in the “PAID” area on the lower right of the screen. The screen is then returned to the state shown in FIG. 1.

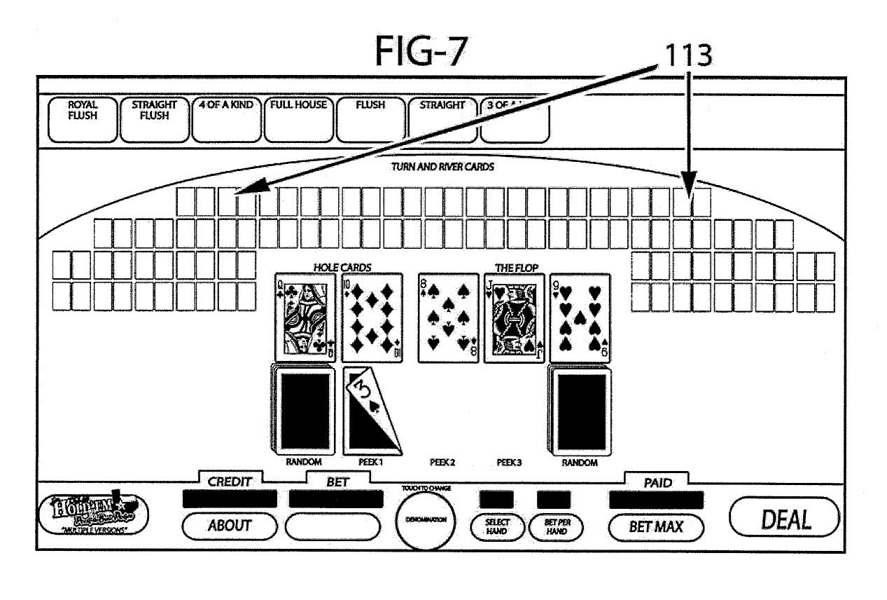

Virtually any number of hands can be played, depending upon the constraints of the system. For example, FIG. 7 illustrates the turn and river card display area for a fifty play game, under an embodiment. For the fifty play game, the turn and river cards will be dealt into their respective fields 113 and paid out accordingly to the best five card poker out of the seven cards comprising the hole, flop, turn and river cards.

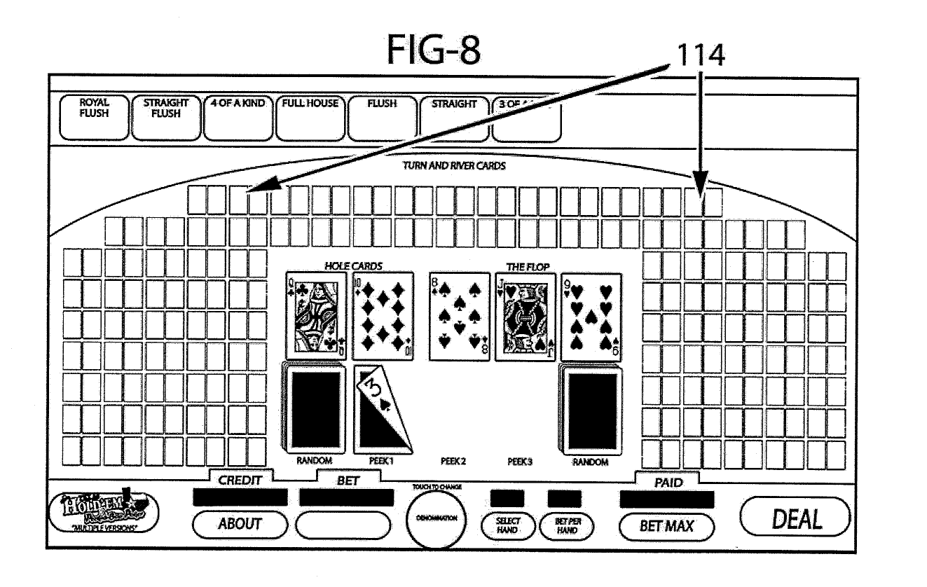

FIG. 8 illustrates the turn and river card display area for a hundred play game, under an embodiment. For the hundred play game, the turn and river cards will be dealt into their respective fields 114 and paid out accordingly to the best five card poker out of the seven cards comprising the hole, flop, turn and river cards.

As shown by FIGS. 6, 7 and 8, any number of hands, such as from 1 to 100 hands can be played through the basic game screen. The Texas holdem peek-a-boo poker game applies to multiple “fields”. The mechanics of the betting and payout processes for each hand of poker may be implemented as known in present versions of electronic poker systems.

In one embodiment, the Texas holdem peek-a-boo poker game system is implemented in a kiosk or console-based system consisting of a number of individual game consoles connected to one another within an area such as a room or portion of a casino. For this embodiment, each game platform is an individual console that can accommodate a single player, each console has its own display, input/output or controller section, and money or chip slot, if necessary. A big-screen display is positioned in the region of the consoles to display the community game. For the console-based gaming system, a number of individual game consoles may be positioned in relatively close proximity to one another and networked together through appropriate electronic hardware. A common display screen of a sufficiently large size is positioned so that it is visible to all of the players of the individual consoles. Alternatively, each console can display its own game screen, as illustrated in FIG. 1.

In one embodiment, the Texas holdem peek-a-boo poker game is executed as a server process that operates in a client-server system for a number of networked game consoles. In this case, one of the game consoles is configured as a server computer that executes the server-side poker game. Each of the other game consoles executes a client-side version of the poker game. The server-side process is responsible for processing and displaying the community game.

The game consoles for the networked embodiments can be implemented as video poker machines that include display devices or monitors that display the game according to embodiments. The video poker machines also include one or more central processing units. The video poker machines also include input and output devices for receiving input from a player and generating appropriate output. For example, input devices include buttons for the player to push, and a touch screen the player can touch to select and/or move items displayed. Output devices include the monitor and speakers for outputting audio information and sound effects.

The game console environment can be provided in a casino licensed to accept wagers and pay bets. Alternatively, the venue may be a private residence where players play the game privately. In yet another alternative, the venue may be an establishment that provides the electronic video game for amusement only and where no real money is wagered while playing the game. Several other alternatives are also possible.

Besides the networked game console implementation, the Texas holdem peek-a-boo poker game system can be implemented in an online or distributed computer network environment. In this implementation, the players need not be in close proximity with one another, but can instead play from a computer or processing device in their home or other remote location. For this embodiment, each remote game console executes a client side version of the Texas holdem peek-a-boo poker game and one of the networked consoles is configured as a server. For this embodiment, the server hosts the community game and coordinates the display of the community game. Alternatively, each of the game consoles executes a standalone version of the Texas holdem peek-a-boo poker game. In this configuration, the community game is synchronized through a common synchronization process. The network coupling the game consoles can be a wide area network (WAN), a local area network (LAN), the Internet, or any other network via which the electronic poker game data can be effectively transferred.

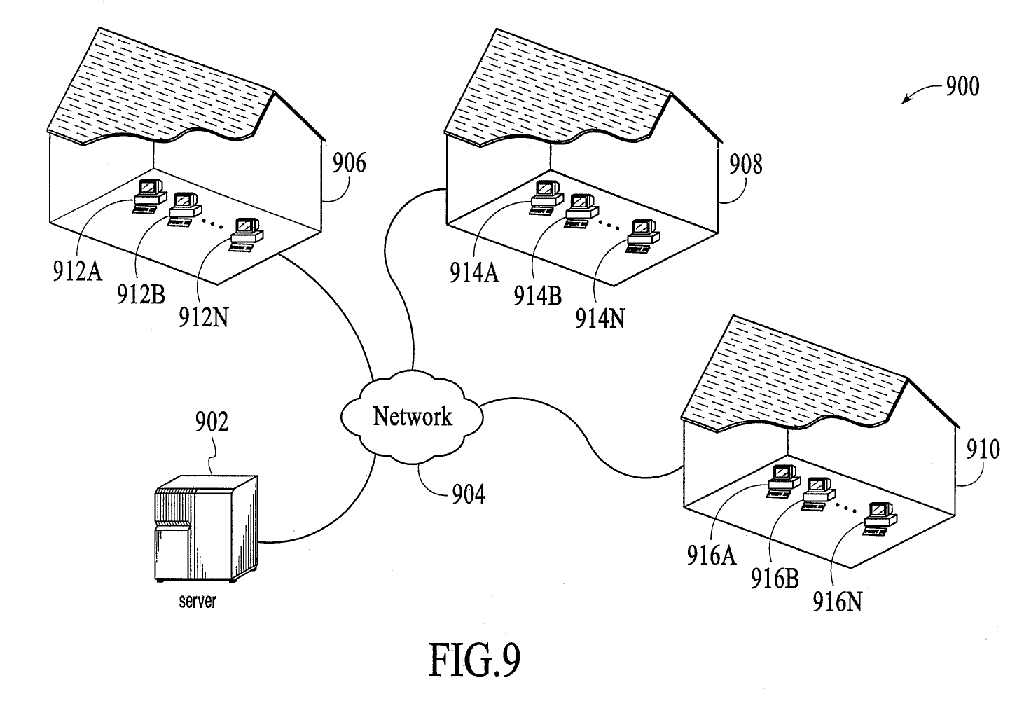

FIG. 9 is a block diagram of an electronic gaming system 900 according to an embodiment. System 900 includes a server 902 that hosts and serves the Texas holdem peek-a-boo poker game as described herein. The server 902 can include any known data servers, storage devices and/or processors capable of communicating via a network. The server 902 is coupled to a network 904 that can be a wide area network (WAN), a local area network (LAN), the Internet, or any other network via which the electronic video game data can be effectively transferred.

Various venues 906, 908, and 910 are coupled to the network 904 for receiving the Texas holdem peek-a-boo poker game from the server 902. Each of the venues 906, 908, and 910 include video poker machines. The video poker machines include display device or monitors that display the game as shown in FIGS. 1-8. The video poker machines also include one or more central processing units. The video poker machines also include input and output devices for receiving input from a player and generating appropriate output. For example, input devices include buttons for the player to push, and a touch screen the player can touch to select and/or move items displayed. Output devices include the monitor and speakers for outputting auditory information and sound effects.

Venue 906 includes machines 912A and 912B through 912N. Venue 909 includes machines 914A and 914B through 914N. Venue 910 includes machines 916A and 916B through 916N.

One or more of the venues 906, 908, and 910 can be casinos licensed to accept wagers and pay bets. Alternatively, one or more of the venues 906, 908, and 910 can be private residences that purchase the electronic video poker game and play the game privately. In yet another alternative, one or more of the venues 906, 908 and 910 are establishments that provide the electronic video poker game to patrons for amusement only and no real money is wagered while playing the game. Other alternatives are possible.

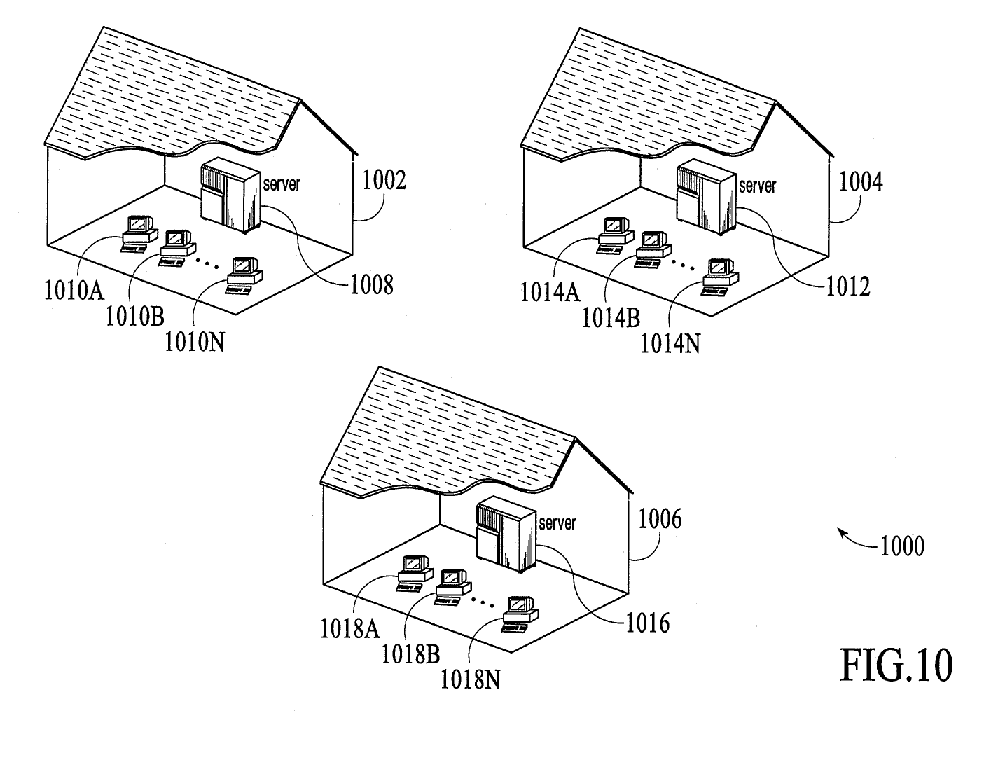

FIG. 10 is a block diagram of an electronic gaming system 1000 according to another embodiment. System 1000 includes venues 1002, 1004 and 1006. Each of the venues 1002, 1004 and 1006 include a server that stores and serves the Texas holdem peek-a-boo poker game as described herein. Each of the venues 1002, 1004 and 1006 further include video poker machines that display the game as shown in FIGS. 1-8. Venue 1002 includes server 1008 and machines 1010A and 1010B through 1010N. Venue 1004 includes server 1012 and machines 1014A and 1014B through 1014N. Venue 1006 includes server 1018 and machines 1018A and 1018B through 1018N.

Further variations on the system configurations shown in FIGS. 9 and 10 are also within the scope of the claimed invention.

Aspects of the one or more embodiments described herein may be implemented on one or more computers, game platforms, or computing devices executing software instructions. The computers may be networked in a client-server arrangement or similar distributed computer network. In one embodiment, the Texas holdem peek-a-boo poker game system may be implemented in a World-Wide Web (WWW) environment in which a server or server clustering environment stores data in the form of web pages and transmits these pages as Hypertext Markup Language (HTML) files over the Internet to the client computers. For this embodiment, the client computers typically run a web browser program to access the web pages served by the server computer and any available content provider or supplemental server.

The network client computers are configured to run a client-side process that implements embodiments of the Texas holdem peek-a-boo poker game program. The client computer may be any type of suitable computing device, such as a game kiosk or console, personal computer, workstation computer, notebook computer, personal digital assistant (PDA), mobile phone, smartphone, or any similar class of mobile computing device with sufficient processing, communication, and audio/video playback capability. For the networked embodiments, any of the processes executed on any of the client and/or server computers may be standalone programs executed locally on the respective client computer, or they can be portions of a distributed client application run on the client or a network of client computers. Such programs may also be referred to by other terms, such as “module,” “component,” and “process.” These terms may be used interchangeably to mean a computer program, routine, or subroutine that is executed on any of the server and/or client computers, and may be implemented as software, firmware, or programmed hardware.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other systems and methods for video card games, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims, but should be construed to include all systems and methods that operate under the claims. Accordingly, the systems and methods are not limited by the disclosure, but instead the scope of the systems and methods is to be determined entirely by the claims.

While certain aspects of the systems and methods are presented below in certain claim forms, the inventors contemplate the various aspects of the systems and methods in any number of claim forms. For example, while only one aspect of the systems and methods may be recited as embodied in machine-readable medium, other aspects may likewise be embodied in machine-readable medium. Accordingly, the inventors reserve the right to add additional claims after filing the application to pursue such additional claim forms for other aspects of the systems and methods.

What is claimed is:

1. A method of playing a card game, the method comprising:
presenting a plurality of peek cards to a player, the peek cards comprising cards with their value partially revealed;
presenting three flop cards to the player, the flop cards displayed to fully reveal their value and suit, and representing three of five community cards;
receiving a player input indicating a first choice of card to be used as a first hole card, the first choice selected from one of an unturned deck of cards or one of the plurality of peek cards;
receiving a player input indicating a second choice of card to be used as a second hole card, the second choice selected from one of an unturned deck of cards or one of the plurality of peek cards, wherein the first and second hole cards represent two private cards;
presenting a turn card to the player, the turn card displayed to fully reveal its value and suit, and representing one of the five community cards;
presenting a river card to the player, the river card displayed to fully reveal its value and suit, and representing one of the five community cards; and
determining the best five card poker hand that can be formed from the two private cards and the five community cards.

2. The method of claim 1 wherein the peeked cards are displayed as cards with a corner folded over to reveal a value and suit.

3. The method of claim 2 further comprising receiving a bet from the player prior to the presentation of the three flop cards.

4. The method of claim 3 further comprising receiving an additional bet from the player following the presentation of the flop cards, the turn card, and the river card so that a total of four bets is received from the player for each hand unless the player folds prior to presentation of the river card.

5. The method of claim 4 further comprising:
determining whether the player is to be paid after the presentation of the river card; and
displaying a paid amount to the player in accordance with a pay table in the event that the player is to be paid.

6. The method of claim 5 wherein the pay table lists the amount to be paid out for various hands of a five card poker game.

7. The method of claim 6 wherein any number of hands between 1 and 100 may be played.

8. The method of claim 7 wherein the turn and river cards are displayed for all hands to be played.

9. The method of claim 1, wherein the card game is an electronic card game and wherein the player input is received electronically, comprising at least one of the player touching a touch screen to indicate a choice or the player entering commands through a keyboard.

10. The method of claim 9 wherein the card game is a community game is displayed on a common display viewable by all of the participating players at one time.

11. The method of claim 9 wherein the card game is played by the user on an individual computing platform remotely coupled to one or more other computing platforms operated by other players over a wide area network.

12. An electronic video card game system, comprising:
a plurality of video poker machines each of which comprises,
an output display device configured to display a video card game; and
an input device configured to receive user input regarding game play;
a server configured to store instructions comprising a video card game, wherein the server communicates with the plurality of video poker machines via at least one network, and wherein the instructions, when executed, cause the video card game to be played on the plurality of video poker machines, the video card game comprising:
presenting a plurality of peek cards to a player, the peeked cards comprising cards with their value partially revealed;
presenting three flop cards to the player, the flop cards displayed to fully reveal their value and suit, and representing three of five community cards;
receiving a player input indicating a choice of two cards hole cards, each choice selected from one of an unturned deck of cards or one of the plurality of peek cards, wherein the hole cards represent two private cards;
presenting a turn card and a river card to the player, both the turn card and river card displayed to fully reveal their value and suit, and representing two of the five community cards; and
determining the best five card poker hand that can be formed from the two private cards and the five community cards.

13. The system of claim 12 wherein the plurality of video poker machines is distributed among a plurality of venues.

14. The system of claim 12 wherein the server and plurality of video poker machines is located at a venue.

15. The system of claim 12 wherein the server and plurality of video poker machines are coupled over the Internet, and wherein the server comprises a web server process accessed through web browsers executed on each of the plurality of video poker machines.

16. A computer-readable medium having instructions stored thereon which, when executed by a processor case a video poker method to be performed, the method comprising:
presenting three flop cards to a player, the flop cards displayed to fully reveal their value and suit, and representing three of five community cards;
receiving a player input indicating a choice of two cards hole cards, each choice selected from one of an unturned deck of cards or one of the plurality of peek cards, wherein the hole cards represent two private cards;
presenting a turn card and a river card to the player, both the turn card and river card displayed to fully reveal their value and suit, and representing two of the five community cards; and
determining the best five card poker hand that can be formed from the two private cards and the five community cards.

17. The medium of claim 16, wherein the video poker game is an electronic card game and wherein the player input is received electronically, comprising at least one of the player touching a touch screen to indicate a choice or the player entering commands through a keyboard.

18. The medium of claim 17 wherein a plurality of additional players interacts with the player through respective game platforms.

19. The medium of claim 18 wherein the additional players are remotely coupled over a wide area network and wherein the respective game platforms comprise personal computer workstations.

20. The medium of claim 19 wherein the video poker game is an online poker game served by a web server, and wherein each of the respective game platforms comprises a computer executing a web browser.
